(19) United States
(12) Patent Application Publication
(10) Pub. No.: US 2005/0283829 A1
(43) Pub. Date: Dec. 22, 2005

(54) Connection method

(75) Inventors: Oleg Zhurakivsky, Helsinki (FI); Hannu Tuominen, Kauniainen (FI); Jukka Tuomi, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/002,632

(22) Filed: Dec. 3, 2004

(30) Foreign Application Priority Data
Jun. 18, 2004 (GB) GB 0413684.2

(51) Int. Cl. G06F 15/16; H04K 1/00; G06F 17/30; H04L 9/00; G06F 7/04; G06F 7/58; G06K 19/00; G06K 9/00; H04L 9/32

(52) U.S. Cl. 726/4; 713/182

(57) ABSTRACT

This invention relates to a method for permitting user equipment operating in accordance first standard to connect to a network operating in accordance with a second standard, said method comprising, sending from said user equipment to said network first identity information, providing in said network second identity information for said user equipment and establishing a connection identified by said first and second identity information between said user equipment and said network.

### FIELD OF THE INVENTION

The present invention relates to a method for permitting user equipment operating in accordance first standard to connect to a network operating in accordance with a second standard.

### BACKGROUND OF THE INVENTION

A communication system is a facility that enables communication between two or more entities such as user terminal equipment and/or network entities in other nodes associated with communication system. The communication may comprise, for example, communication of voice, electronic mail (email), text messages, data multimedia and so on.

The communication may be provided by fixed line and/or wireless communication interfaces. A feature of wireless communication systems is that they provide mobility for the users thereof. An example of a communication system providing wireless communication is a public mobile network (PLMN). An example of the fixed line system is a public switched telephone network (PSTN). A cellular telecommunication system is a communication system that is based on the use of radio access entities and/or wireless service areas. The access entities were typically referred to as cells. Examples of cellular telecommunication standards includes standards such as GSM (global system for mobile communications), GPRS (general packet radio service) AMPS (American mobile phone system), DAMPS (Digital AMPS), WCDMA (Wide band code division multiple access), UMTS (universal mobile telecommunication system) and CDMA 2000 (Code division multiple access 2000).

A communication system typically operates in accordance with a given standard or specification which sets out what the various elements of a system are permitted to do and how that should be achieved. For example, the standard or specification may define if the user, or more precisely user equipment is provided with a circuit switched service or a packet switched service or both. Communication protocols and/or parameters that should be used for the connection are also typically defined. For example, the manner in which communication shall be implemented between the user equipment and the elements of the communication network is typically based on a predefined communication protocol.

Mobile stations which have a GPRS capability are known. It has also been proposed to provide those stations with a (wireless local area network) WLAN capability. However, the WLAN part of the mobile station is not able to obtain GPRS services. This is because in order to obtain a GPRS service, a GPRS subscriber requires a unique identity. The unique identity is made up of an IMSI (international mobile subscriber identity) and NSAPI (network layer service access point identity). Thus, a GPRS subscriber will have a unique identity in the GPRS network. The IMSI is unique to the subscriber. The NSAPI effectively indicates a connection number. For a given connection, the combination of the IMSI and NSAPI needs to be unique.

However, there is no way that a WLAN client is able to obtain the NSAPI. Accordingly, the WLAN client is unable to obtain GPRS services from a GPRS network.

It is an aim of embodiments of the present invention to address the above problem.

### SUMMARY OF THE INVENTION

According to a first aspect in the present invention, there is provided a method for permitting user equipment operating in accordance first standard to connect to a network operating in accordance with a second standard, said method comprising sending from said user equipment to said network first identity information, providing in said network second identity information for said user equipment and establishing a connection identified by said first and second identity information between said user equipment and said network.

According to a second aspect in the present invention, there is provided a system comprising user equipment operating in accordance first standard and a network operating in accordance with a second standard, said user equipment being arranged to send to said network first identity information, said network being arranged to provide second identity information for said user equipment and to establish a connection with said user equipment, said connection being identified by said first and second identity information.

According to a third aspect in the present invention, there is provided an entity in a network operating in accordance with a second standard, said entity being arranged to receive first identity information from user equipment operating in accordance with a first standard, said entity being arranged to provide second identity information.

According to a fourth aspect in the present invention, there is provided an entity in a network operating in accordance with a second standard, said entity being arranged to receive first identity information for user equipment operating in accordance with a first standard and second identity information, said entity being arranged to check that the first and second identity information are not already in use.

### BRIEF DESCRIPTION OF DRAWINGS

For a better understanding of the present invention and as to how the same can be carried into effect, reference will now be made by way of example only to the accompanying drawings in which:

FIG. 1 schematically shows an arrangement in which embodiments of the present invention can be incorporated;

FIG. 2 shows a signal flow between the GPRS part of the mobile device and the GGSN of FIG. 1; and

FIG. 3 shows the signal flow between the WLAN part of the mobile device and the GGSN of FIG. 1.

### DETAILED DESCRIPTION OF PREFERRED EMBODIMENTS OF THE PRESENT INVENTION

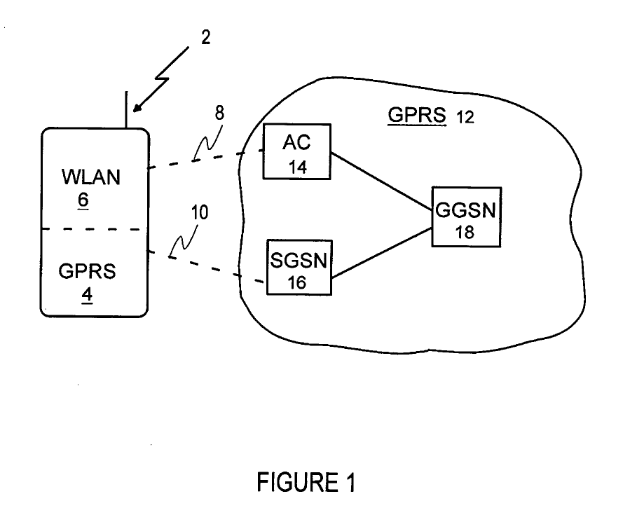

Reference is now made to FIG. 1 which shows a system in which embodiments of the present invention can be incorporated.

FIG. 1 shows user equipment 2. The user equipment 2 has a WLAN part 6 and a GPRS part 4. The WLAN part 6 allows the user equipment to connect to a WLAN whilst the GPRS part 4 allows the user equipment to connect to a GPRS network.

The user equipment can take any suitable form such as computers (fixed or portable), mobile telephones, personal data assistants or organisers and so on. The user equipment 2 is a wireless device such that the user equipment 2 will communicate via a wireless interface with another device such as a base station. For clarity, the radio access network has been omitted but in practise will be between the user equipment 2 and the GPRS network 12.

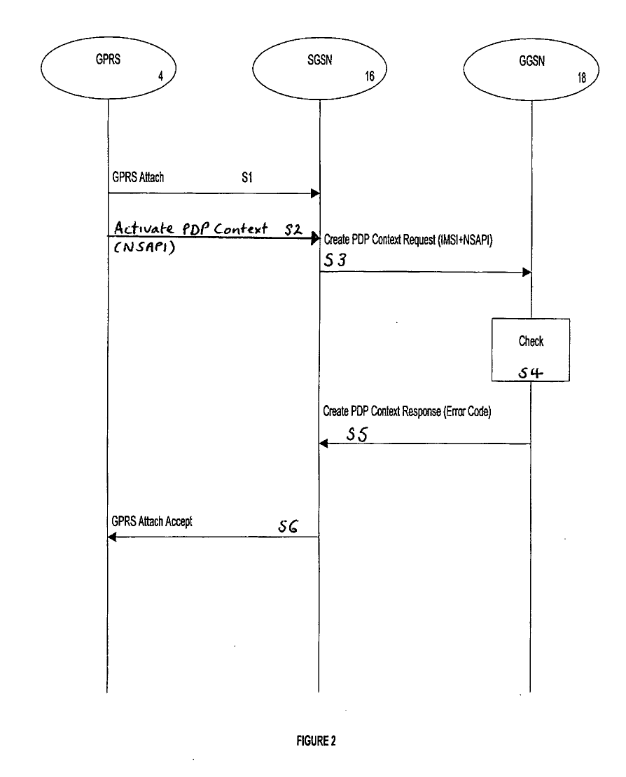

The GPRS part 4 of the user equipment is arranged to communicate with the GPRS network 12 in a conventional way. In particular, the GPRS part 4 communicates with a SGSN (signalling GPRS support node) 16 via path 10. Path 10 will go via the radio access network (not shown). The SGSN 16 is connected to a GGSN gateway GPRS support node 18. The signalling between the GPRS part 4 of the user equipment and the GGSN 18 will be described later with reference to FIG. 2.

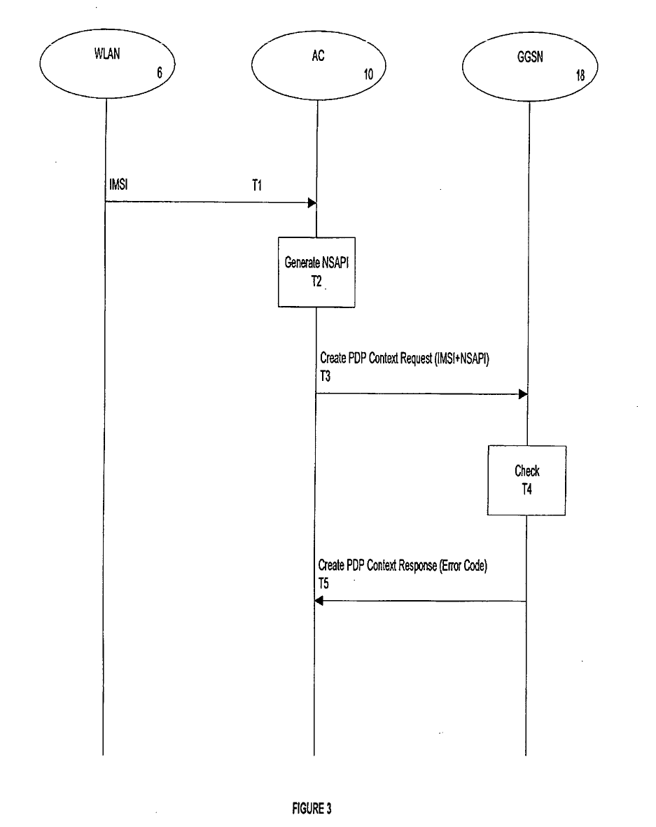

The WLAN part 6 of the user equipment is arranged to communicate with an access controller 14 of the GPRS network 12 via path 8. Again, path 8 goes through the radio access network (not shown). The access controller 14 is also connected to the GGSN 18. The signal flow between the WLAN part 6 of the user equipment and the GGSN will be described later with reference to FIG. 3.

Reference is now made to FIG. 2 which describes the signalling between the GPRS part 4 of the user equipment and the GGSN 18.

In step S1, the GPRS part 4 of the user equipment 2 sends a GPRS ATTACH message to the SGSN 16. This ATTACH message will include the IMSI. After the GPRS attach procedure is successfully completed, in step S2 the user equipment sends an Activate PDP (Packet Data Protocol) Context message to the SGSN in order to activate a PDP Context. This Activate PDP Context Request message will include a NSAPI. The GPRS part of the user equipment will allocate the NSAPI to the connection.

In step S3, the SGSN 16 sends a Create PDP Context Request GTP (GPRS Tunnelling Protocol) message to the GGSN 18. This message will include IMSI and NSAPI provided by the GPRS part of the user equipment.

In step S4, the GGSN checks that there is no other connection with the same IMSI and NSAPI values. In other words, the GGSN is checking to make sure the GPRS part 4 of the user equipment has not previously activated a connection with the same NSAPI.

Assuming that the GPRS part 4 of the user equipment has not previously activated such a connection, the next step is step S5 where the GGSN 18 sends a Create PDP Context Response GTP message to the SGSN indicating that the PDP (Packet data protocol) context is successfully set up in the GGSN.

In step S6, the SGSN then informs GPRS part of the user equipment with the Activate PDP Context Accept message. In this way, a connection between the GPRS part of the user equipment and the GPRS network is activated.

Reference is now made to FIG. 3 which shows the signalling flow between WLAN part 6 of the user equipment and the GGSN 18.

In step T1, the WLAN part 6 sends the IMSI to the access controller 14. As discussed previously, the WLAN part 6 is not able to generate a NSAPI.

In step T2, the access controller 14 generates an NSAPI for the WLAN part 6.

In step T3, the IMSI and the generated NSAPI are sent to the GGSN 18 by the access controller with the Create PDP Context Request GTP message.

In step T4, the GGSN checks to make sure there is no other connection with the identical IMSI and identical NSAPI.

If there is no other such connection, the next step is step T5, where the GGSN sends to the access controller a Create PDP Context Response message.

On a successful completion of the Create PDP Context GTP dialog the Access Controller then grants the WLAN part of the user equipment access to the GPRS packet service.

If it is determined that there is already a connection with the identical IMSI and NSAPI, then in the step T5 the Create PDP Context Response GTP message sent from the GGSN to the Access Controller will contain the error code, for example a GTP Cause value indicating the cause of the error, such as the ‘NAPSI is busy’.

The error code received in step T5 causes the access controller and the GGSN to repeat steps T2, T3, T4 and T5.

It should be appreciated that when the GGSN 18 is doing its check, it will check all of the connections associated with the particular IMSI. Accordingly, it will check both those connections set up by the GPRS part 4 as well as the WLAN part 6. This is true for both FIGS. 2 and 3.

In one embodiment of the present invention the access controller is free to choose any NSAPI and may do so at random or may do it in number order. Typically, the NSAPI will have a number between 0 to 15.

It is proposed a the GPRS user equipment can only use some addresses, for example 5 to 16, for the NSAPI value. Accordingly, in one embodiment of the present invention, the access controller can be set up to select only some of the addresses, for example addresses 0 to 4 for the NSAPI.

In the embodiment described in relation to FIG. 3, the access controller 14 is arranged to generate the NSAPI. In one modification to the invention, the NSAPI may be selected by the GGSN. As the GGSN has a store which stores all of the IMSI and NSAPI values for connections of the user equipment, the GGSN will be able to select an appropriate value for the NSAPI which is not currently in use.

In yet another modification to the invention, the GPRS part of the user equipment may be able to pass an NSAPI value to WLAN part 6 in response to a request from WLAN part 6.

The arrangement shown in the described embodiment of the present invention shows user equipment having both a GPRS part 4 and a WLAN part 6. It should be appreciated that embodiments of the present invention can of course be used with user equipment having only a WLAN part 6. In this way conflicts between different connections of the same user equipment.

The IMSI and NSAPI uniquely identifies the PDP context associated with the PDP address. As mentioned, each GPRS subscriber can activate up to 16 PDP contexts, 1 primary and 15 PDP contexts. When a GPRS subscriber requests a PDP context activation it selects one of its unused NSAPIs.

In one modification to the invention if the GGSN sees in step T4 that there is an NSAPI conflict and the subscribers access type is WLAN, the GGSN may be arranged to indicate with the error code that the NSAPI value is already used by the GPRS part of the user equipment and return this information to the access controller. In this way, it can be ensured that the existing connection with the same NSAPI value is not torn down.

In one modification to the invention, if the GPRS subscriber tries to activate a PDP context with an NSAPI value already used by the WLAN subscriber the GGSN may reject the activation and provide the subscriber with an error message. This may cause the GPRS subscriber to try again with a different NSAPI value.

It should be appreciated that in preferred embodiments of the present invention, the GPRS access of the user equipment is in accordance with the third generation GPRS proposals. It should be appreciated that there are third generation 3GPP specifications which define WLAN interworking such as for example, 3GPP TS 23.234. This describes an interworking architecture. The described architecture describes an entity called a packet data gateway. The access controller may be part of the packet data gateway or may be a separate entity.

Embodiments of the present invention may be arranged to used with other standards other than WLAN and GPRS.

1. A method for permitting user equipment operating in accordance with a first standard to connect to a network operating in accordance with a second standard, said method comprising;
sending first identity information from a user equipment to a network;
providing in said network second identity information for said user equipment; and
establishing a connection identified by said first identity information and said second identity information between said user equipment and said network.

2. A method as claimed in claim 1, further comprising the step of:
checking that said first identity information and said second identity information are not already in use.

3. A method as claimed in claim 2, wherein said checking step is performed when said user equipment is operating in accordance with a second standard and makes a connection with said network.

4. A method as claimed in claim 2, further comprising the step of:
sending an error message when it is determined that said first identity information and said second identity information are already in use.

5. A method as claimed in claim 2, further comprising the step of:
sending new second identity information when it is determined that said first identity information and said second identity information are already in use.

6. A method as claimed in claim 1, wherein said providing step comprises sending said first identity information comprising International Mobile Subscriber Identity (IMSI).

7. A method as claimed in claim 1, wherein said providing step comprises providing said second identity information comprising Network Layer Service Access Point Identity (NSAPI).

8. A method as claimed in claim 1, wherein said sending step comprises sending said first identity information from said user equipment, wherein said user equipment is configured to operate in accordance with a second standard.

9. A method as claimed in claim 1, wherein said method permits user equipment to operate in accordance with a Wireless Local Area Network (WLAN) standard.

10. A method as claimed in claim 1, wherein a second standard comprises a General Packet Radio Service (GPRS) standard.

11. A method as claimed in claim 1, wherein said providing step takes place in at least one of an access controller of said network and a Gateway General Packet Radio Service Serving/Support Node (GGSN).

12. A method as claimed in claim 11, wherein said providing step comprises selecting of said second identity information by said access controller.

13. A method as claimed claim 1, wherein said providing step comprises selecting one of at least one value reserved for user equipment operating in accordance with first standard.

14. A method as claimed in claim 1, wherein said providing step comprises determining an available second identity information.

15. A system, comprising:
user equipment operating in accordance with a first standard; and
a network operating in accordance with a second standard, said user equipment being arranged to send first identity information to said network, said network being configured to provide second identity information for said user equipment and to establish a connection with said user equipment, said connection being identified by said first identity information and said second identity information.

16. An entity in a network, said network operating in accordance with a second standard, said entity being arranged to receive first identity information from a user equipment operating in accordance with a first standard, and said entity being arranged to provide second identity information.

17. An entity as claimed in claim 16, wherein said entity comprises at least one of a Gateway General Packet Radio Service Serving/Support Node (GGSN) and an access node.

18. An entity as claimed in claim 16, wherein said entity is arranged to select a second identity from a plurality of options for said second identity.

19. An entity as claimed in claim 18, wherein said entity is arranged to select said second identity for said user equipment which, in association with said first identity, is not already in use.

20. An entity in a network operating in accordance with a second standard, said entity being arranged to receive first identity information for a user equipment operating in accordance with a first standard and second identity information, said entity also being arranged to check that the first identity information and the second identity information are not already in use.

21. An entity as claimed in claim 20, wherein when said first identity information and second identity information are already in use, said entity is arranged to provide an error message.

22. An entity as claimed in claim 20, wherein when said first identity information and second identity information are already in use, said entity is arranged to provide new second identity information.

23. A user equipment operating in accordance with a first standard to connect to a network operating in accordance with a second standard, said user equipment comprising;
sending means for sending first identity information from a user equipment to a network;
providing means for providing in said network second identity information for said user equipment; and
establishing means for establishing a connection identified by said first identity information and said second identity information between said user equipment and said network.
